(19) United States
(12) Patent Application Publication
(10) Pub. No.: US 2020/0211595 A1
(43) Pub. Date: Jul. 2, 2020

(54) SUBSTRATE FOR MAGNETIC RECORDING MEDIUM, MAGNETIC RECORDING MEDIUM, HARD DISK DRIVE

(71) Applicant: SHOWA DENKO K.K., Tokyo (JP)

(72) Inventors: Koji YUKIMATSU, Oyama-shi (JP); Hiroyuki MACHIDA, Oyama-shi (JP); Sho YOKOYAMA, Oyama-shi (JP)

(73) Assignee: SHOWA DENKO K.K., Tokyo (JP)

(21) Appl. No.: 16/727,549

(22) Filed: Dec. 26, 2019

(30) Foreign Application Priority Data
Dec. 28, 2018 (JP) 2018-247148

(51) Int. Cl. G11B 5/73; G11B 5/82

(52) U.S. Cl. CPC G11B 5/73919; G11B 5/82

(57) ABSTRACT

The present invention provides a substrate for a magnetic recording medium in which bulges are hardly formed on a surface thereof by a physical impact in a size for a 3.5-inch type HDD, and a width of displacement caused by fluttering is small. The substrate for a magnetic recording medium includes an Al alloy substrate and a Ni alloy plating film formed on a surface of the Al alloy substrate, and has a diameter of 95 to 98 mm, a disk shape having a hole whose inner diameter ranges from 19 to 26 mm in the center thereof, a thickness of 0.48 to 0.64 mm, and a mass of 9.0 to 15.0 g. The Al alloy substrate has a Young's modulus (E) of 74 GPa or more, a density (ρ) of 2.75 g/cm³ or less, and a ratio (E/ρ) of 27 or more between the Young's modulus (E) and the density (ρ). The Ni alloy plating film has a thickness of 4 to 7 μm, and when an indentation is formed by pressing a diamond indentor whose tip has a square pyramid shape against a surfaces of the Ni alloy plating film with a test force of 0.49 N for 10 seconds in a vertical direction, an average height of bulges generated around the indentation ranges from 10 to 50 nm.

### BACKGROUND OF THE INVENTION

### Field of the Invention

The present invention relates to a substrate for a magnetic recording medium, a magnetic recording medium, and a hard disk drive (HDD).

Priority is claimed on Japanese Patent Application No. 2018-247148, filed Dec. 28, 2018, the content of which is incorporated herein by reference.

### Description of Related Art

In recent years, a magnetic recording medium used in a hard disk drive has been remarkably improved in recording density. Especially, an increase in a surface recording density of the magnetic recording medium has been further intensified since magnetoresistive (MR) head or partial response maximum likelihood (PRML) technology was introduced.

Further, due to the recent development of Internet networks and the recent expansion of utilization of big data, a stored volume of data in a data center also continues to increase. Due to space issues of data centers, the necessity for increasing a recording capacity per unit volume in a data center occurs. That is, to increase a recording capacity per one standardized hard disk drive, in addition to increasing a recording capacity per a magnetic recording medium, there have been attempts to increase the number of magnetic recording media stored in a drive case.

An aluminum alloy substrate and a glass substrate are mainly used as a substrate for a magnetic recording medium. Of these substrates, the aluminum alloy substrate has higher toughness and is more easily fabricated compared to the glass substrate, and thus is used for a magnetic recording medium whose outer diameter is relatively large. Since the thickness of the aluminum alloy substrate used for a magnetic recording medium of a 3.5-inch type hard disk drive is typically 1.27 mm, a maximum of five magnetic recording media can be stored in the drive case.

To increase the number of magnetic recording media stored in the drive case, there have been attempts to thin the substrate used for the magnetic recording medium.

However, in the case where the substrate is thinned, the aluminum alloy substrate has a problem in that fluttering is more easily caused compared to the glass substrate.

The fluttering is flapping of the magnetic recording medium caused when the magnetic recording medium is rotated at a high speed. If the fluttering increases, it is difficult to stably read magnetic information of the hard disk drive.

For example, it is known that, to limit fluttering in a glass substrate, a material having high specific elasticity (a specific Young's modulus) is used as a material of the substrate for a magnetic recording medium (e.g., see Japanese Unexamined Patent Application, First Publication No. 2015-26414).

Further, technology for filling the inside of the drive case of a 3.5-inch type hard disk drive with helium gas and reducing fluttering is known. Thus, the aluminum alloy substrate can be thinned, and there have been attempts to store six or more magnetic recording media in a drive case.

A substrate for a magnetic recording medium is generally fabricated by the following processes.

First, an aluminum alloy ingot is rolled to obtain an aluminum alloy sheet material having a thickness of about 2 mm or less, and the aluminum alloy sheet material is punched in a disk shape to obtain desired dimensions.

Next, chamfering of inner and outer diameters and turning of data surfaces are performed on the disk of the punched aluminum alloy sheet material. Afterward, in order to reduce surface roughness and waviness of the aluminum alloy sheet material, the aluminum alloy sheet material is ground by grindstone to obtain an aluminum alloy substrate. Next, for the purpose of application of surface hardness and slimitation of surface defects, surfaces of the aluminum alloy substrate are plated with a nickel alloy such as NiP. Next, polishing is performed on both surfaces (data surfaces) of the aluminum alloy substrate on which a nickel alloy plating film is formed.

Because the substrate for a magnetic recording medium is a mass-produced product and requires high cost performance, high machinability and inexpensiveness are required of an aluminum alloy.

Japanese Unexamined Patent Application, First Publication No. 2009-24265 disclose an aluminum alloy that contains 0.3 to 6% by mass of Mg, 0.3 to 10% by mass of Si, 0.05 to 1% by mass of Zn, and 0.001 to 0.3% by mass of Sr, and a balance composed of Al and impurities.

PCT International Publication No. WO2016/068293 disclose an aluminum alloy substrate for a magnetic disk that contains no less than 0.5% by mass and no more than 24.0% by mass of Si, and no less than 0.01% by mass and no more than 3.00% by mass of Fe, and a balance composed of Al and inevitable impurities.

Japanese Unexamined Patent Application, First Publication No. H06-145927 discloses a method for manufacturing an Al—Mg based alloy rolled sheet for a magnetic disk, which includes continuously casting an Al—Mg based alloy containing 2.0 to 6.0 wt % of Mg into a plate having a thickness of 4 to 10 mm, cold-rolling the cast plate at a high processing rate of 50% or higher without performing uniform heat treatment, and then performing annealing at a temperature of 300 to 400° C. to make a rolled sheet whose surface layer portion has an average grain size of 15 μm or less. Here, the Al—Mg based alloy contains 2.0 to 6.0 wt % of Mg, and 0.01 to 0.1 wt % of one or both of Ti and B, and further contains one or both of 0.03 to 0.3 wt % of Cr and 0.03 to 0.3 wt % of Mn.

Japanese Unexamined Patent Application, First Publication No. 2017-120680 discloses, in order to provide a substrate for a magnetic recording medium having a high Young's modulus and excellent machinability, a technique in which, in the alloy structure of an aluminum alloy substrate including Mg in a range of 0.2% to 6% by mass, Si in a range of 3% to 17% by mass, Zn in a range of 0.05% to 2% by mass, and Sr in a range of 0.001% to 1% by mass, the average particle diameter of Si particles is set to 2 μm or less.

### SUMMARY OF THE INVENTION

The substrate for a magnetic recording medium used as the substrate for a magnetic recording medium for a hard disk drive is preferably not easily deformed by a physical impact, for instance, when the hard disk drive is dropped or when a magnetic head of the hard disk drive and the magnetic recording medium come into contact with each other. However, if any of the conventional aluminum alloy substrates for a magnetic recording medium set forth in Japanese Unexamined Patent Application, First Publication No. 2009-24265, PCT International Publication No. WO2016/068293, Japanese Unexamined Patent Application, First Publication No. H06-145927 and Japanese Unexamined Patent Application, First Publication No. 2017-120680 receives a physical impact, the conventional aluminum alloy substrate is apt to be easily deformed such that a portion receiving the physical impact is crushed and the periphery thereof is formed into bulges. If bulges are formed on a surface of the magnetic recording medium, the magnetic head and the bulges may come into contact with each other while the hard disk drive is in use, and the magnetic head may be damaged. For this reason, it is desired that bulges are not be easily formed on the surface of the magnetic recording medium. Especially, in order to provide a high storage capacity in the 3.5-inch type hard disk drive, the thickness of the magnetic recording medium is reduced, or a distance between the magnetic head and the magnetic recording medium is narrowed, and thus it is considered that the number of magnetic recording media that can be housed in the drive case is increased. For this reason, a substrate for a magnetic recording medium in which bulges are not easily formed on the surface thereof due to a physical impact, that is, having high hardness or rigidity, is required.

As a method for improving the hardness or the rigidity of a substrate for a magnetic recording medium, a method of increasing the thickness of the nickel alloy plating film may be conceived. However, in this case, the mass of the magnetic recording medium substrate is increased, and the width of displacement due to fluttering (NRRO: None Repeatable Run-Out) may be increased. If the NRRO increases, there is a problem that the magnetic head and the magnetic recording medium easily come into contact with each other when the hard disk drive is in use.

The present invention was made in view of the above circumstances, and an object of the present invention is to provide a substrate for a magnetic recording medium in which bulges are not easily formed on a surface thereof due to a physical impact in a size for a 3.5-inch type hard disk drive, and a width of displacement (NRRO) caused by fluttering is small. Further, an object of the present invention is to provide a magnetic recording medium having the substrate for a magnetic recording medium, and a hard disk drive having the same.

The inventors of the present invention conducted intensive research and found that a substrate for a magnetic recording medium in which bulges are not easily formed on a surface thereof due to a physical impact even in a size for a 3.5-inch type hard disk drive, and a width of displacement (NRRO) caused by fluttering is small can be obtained by using a high-rigidity aluminum alloy substrate such that a size and a mass of the substrate for a magnetic recording medium are set to be within a prescribed range, a substrate in which a Young's modulus E, a density ρ, and a ratio E/ρ between the Young's modulus E and the density ρ are within a prescribed range is used as an aluminum alloy substrate, the thickness of a nickel alloy plating film is set to be within a prescribed range, and when an indentation is formed by pressing a diamond indentor whose tip has a square pyramid shape against a surface of the nickel alloy plating film with a test force of 0.49 N for 10 seconds in a vertical direction, the average height of bulges generated around the indentation is within a prescribed range, and thus completed the present invention.

In order to solve the above problems, the present invention provides the following means.

(1) A substrate for a magnetic recording medium according to an aspect of the present invention includes: an aluminum alloy substrate; and a nickel alloy plating film formed on at least one surface of the aluminum alloy substrate, having a diameter within a range of 95 mm or more and 98 mm or less, a disk shape having a hole whose inner diameter is within a range of 19 mm or more and 26 mm or less in the center thereof, a thickness within a range of 0.48 mm or more and 0.64 mm or less, and a mass within a range of 9.0 g or more and 15.0 g or less. The aluminum alloy substrate has a Young's modulus (E) of 74 GPa or more, a density (ρ) of 2.75 g/cm³ or less, and a ratio (E/ρ) of 27 or more between the Young's modulus (E) in units of GPa and the density (ρ) in units of g/cm³. The nickel alloy plating film has a thickness within a range of 4 μm or more and 7 μm or less, and when an indentation is formed by pressing a diamond indentor whose tip has a square pyramid shape against a surface of the nickel alloy plating film with a test force of 0.49 N for 10 seconds in a vertical direction, an average height of bulges generated around the indentation is within a range of 10 nm or more and 50 nm or less.

(2) A magnetic recording medium according to another aspect of the present invention includes: a substrate for a magnetic recording medium; and a magnetic layer formed on a surface of the substrate for a magnetic recording medium. The substrate for a magnetic recording medium is the substrate for a magnetic recording medium defined in (1) above, and the magnetic layer is formed on the surface of the substrate for a magnetic recording medium on which the nickel alloy plating film is formed.

(3) A hard disk drive according to yet another aspect of the present invention includes a magnetic recording medium. The magnetic recording medium is the magnetic recording medium defined in (2) above.

According to the present invention, a substrate for a magnetic recording medium in which bulges are not easily formed on a surface thereof due to a physical impact in a size for a 3.5-inch type hard disk drive, and a width of displacement (NRRO) caused by fluttering is small can be provided. Further, according to the present invention, a magnetic recording medium having the above substrate for a magnetic recording medium, and a hard disk drive having the magnetic recording medium can be provided.

### BRIEF DESCRIPTION OF THE DRAWINGS

FIG. 1 is a schematic sectional view showing an example of a substrate for a magnetic recording medium according to the present embodiment.

FIGS. 2(a) and 2(b) are views showing a method for measuring an average height of bulges generated around an indentation formed on a surface of a nickel alloy plating film.

FIG. 3 is a perspective view showing an example of a polishing machine that can be used in fabricating the substrate for a magnetic recording medium according to the present embodiment.

FIG. 4 is a schematic sectional view showing an example of the magnetic recording medium according to the present embodiment.

FIG. 5 is a perspective view showing an example of a hard disk drive according to the present embodiment.

### DETAILED DESCRIPTION OF THE INVENTION

Hereinafter, a substrate for a magnetic recording medium, a magnetic recording medium, and a hard disk drive according to embodiments of the present invention will be described in detail with proper reference to the drawings. Note that the drawings used for the following description may show characterized portions in an enlarged scale for convenience in order to facilitate understanding of features of the present invention, and dimensional ratios of the components are not necessarily the same as actual dimensional ratios.

[Substrate for Magnetic Recording Medium]

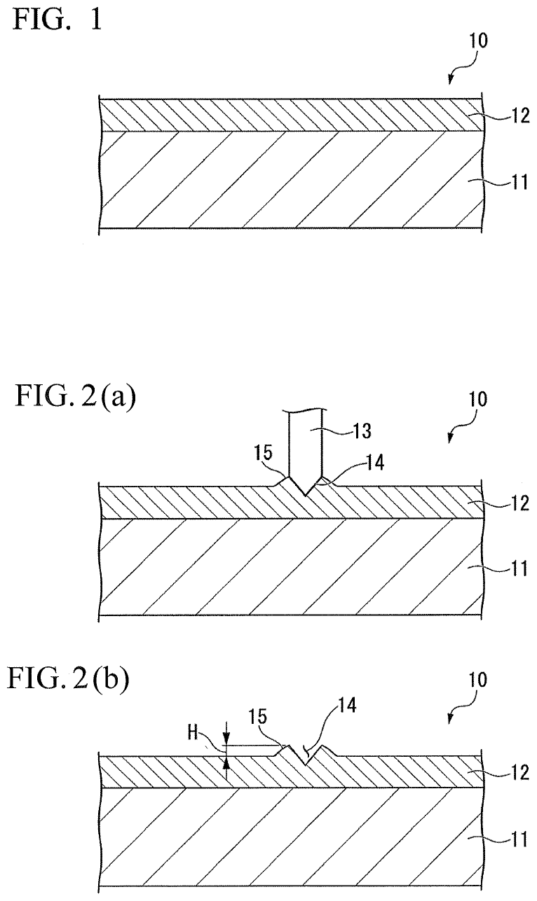

FIG. 1 is a schematic sectional view showing an example of a substrate for a magnetic recording medium according to the present embodiment.

As shown in FIG. 1, a substrate 10 for a magnetic recording medium has an aluminum alloy substrate 11, and a nickel alloy plating film 12 formed on at least one surface of the aluminum alloy substrate 11. The substrate 10 for a magnetic recording medium has the shape of a disk whose diameter is within a range of 95 mm or more and 98 mm or less, which has a central hole whose inner diameter is within a range of 19 mm or more and 26 mm or less, and whose thickness is within a range of 0.48 mm or more and 0.64 mm or less. The diameter of the substrate 10 for a magnetic recording medium is the same as a typical substrate for a magnetic recording medium used for a 3.5-inch type hard disk. The hole of the substrate 10 for a magnetic recording medium is a portion into which a driving shaft of a 3.5-inch type hard disk drive is inserted. The inner diameter of the hole of the substrate 10 for a magnetic recording medium is the same as that of the typical substrate for a magnetic recording medium used for the 3.5-inch type hard disk.

The substrate 10 for a magnetic recording medium of the present embodiment has a mass set to be within a range of 9.0 g or more and 15.0 g or less. Since the mass is within this range, an NRRO (a width of displacement caused by fluttering) can be made small. The mass of the substrate 10 for a magnetic recording medium is preferably within a range of 9.0 g or more and 14.0 g or less, and particularly preferably within a range of 9.0 g or more and 13.0 g or less.

<Aluminum Alloy Substrate>

The aluminum alloy substrate 11 has a Young's modulus E of 74 GPa or more and a density ρ of 2.75 g/cm³ or less, and a ratio E/ρ between the Young's modulus E in units of GPa and the density ρ in units of g/cm³ is set to be more than or equal to 27.

Hereinafter, the reason why physical properties of the aluminum alloy substrate 11 are regulated as described above will be described.

(Young's Modulus E of 74 GPa or More)

The Young's modulus is an index that represents ease of deformation. If the Young's modulus E of the aluminum alloy substrate 11 is increased, the NRRO is apt to be reduced. For this reason, in the present embodiment, the Young's modulus E of the aluminum alloy substrate 11 is set to be more than or equal to 74 GPa. The Young's modulus of the aluminum alloy substrate 11 is preferably within a range of 74 GPa or more and 100 GPa or less.

The Young's modulus is a value measured at room temperature on the basis of the method regulated by Japanese Industrial Standard (JIS) Z 2280-1993 (Test method for Young's modulus of metallic materials at elevated temperature).

(Density ρ of 2.75 g/Cm³ or Less)

If the density ρ of the aluminum alloy substrate 11 is reduced, the NRRO is apt to be reduced. For this reason, in the present embodiment, the density ρ of the aluminum alloy substrate 11 is set to be less than or equal to 2.75 g/cm³. The density ρ of the aluminum alloy substrate 11 varies depending on a composition of the aluminum alloy substrate, but is preferably within a range of 2.60 g/cm³ or more and 2.75 g/cm³ or less.

The density of the aluminum alloy substrate 11 is a value measured by the Archimedes method.

(Ratio E/ρ of 27 or More)

If the ratio E/ρ between the Young's modulus E (in units of GPa) and the density ρ (in units of g/cm³) is increased, fluttering is not easily caused, and the NRRO is apt to be reduced. For this reason, in the present embodiment, the ratio E/ρ is set to be more than or equal to 27. The ratio E/ρ of the aluminum alloy substrate 11 is preferably within a range of 28 or more and 38 or less.

The aluminum alloy substrate 11 may be fabricated, for instance, by a method that includes a casting process of making an aluminum alloy ingot, a rolling process of rolling the aluminum alloy ingot in a sheet shape and obtaining an aluminum alloy sheet material, and a processing process of molding the aluminum alloy sheet material into the aluminum alloy substrate 11.

In the casting process, an aluminum alloy is cast to make an aluminum alloy ingot.

For example, a well-known method used as an aluminum alloy casting method such as a direct chill casting method (a DC casting method) or a continuous casting method (CC) may be used as the method for casting the aluminum alloy. The DC casting method is a method of pouring a molten metal of an aluminum alloy into a mold, directly bringing the mold into contact with cooling water, and casting an aluminum alloy ingot. The continuous casting method is a method of continuously pouring a molten metal of an aluminum alloy into a mold and rapidly cooling the molten metal in the mold.

In the rolling process, the aluminum alloy ingot obtained in the above casting process is rolled in a sheet shape, and thereby an aluminum alloy sheet material is obtained. The rolling process is not particularly limited, and either of a hot rolling method and a cold rolling method may be used as the rolling process. Rolling conditions are not particularly limited, and typical conditions under which an aluminum alloy ingot is rolled may be used.

In the processing process, first, the aluminum alloy sheet material obtained in the above rolling process is punched in a disk shape, and thereby an aluminum alloy disk is obtained. Next, the aluminum alloy disk is heated to a temperature of 300° C. or higher and 500° C. or lower within a range of 0.5 hr or more and 5 hr or less, and is annealed. Strain in the aluminum alloy disk is relieved by performing the annealing, and rigidity of the obtained aluminum alloy substrate can be adjusted within an appropriate range. Next, surfaces and an end face of the annealed aluminum alloy disk are cut using a cutting tool. For example, a diamond bite may be used as the cutting tool. The annealing may be performed after the cutting.

<Nickel Alloy Plating Film>

The nickel alloy plating film 12 has a function of enhancing hardness of the surfaces of the substrate 10 for a magnetic recording medium to improve strength of the substrate 10 for a magnetic recording medium, and a function of planarizing the surfaces of the substrate 10 for a magnetic recording medium to limit surface defects. If the thickness of the nickel alloy plating film 12 is excessively thinned, there is a risk of the above functions not be easy to obtain. On the other hand, if the thickness of the nickel alloy plating film 12 is excessively thickened, the mass of the substrate 10 for a magnetic recording medium is increased, and there is a risk of fluttering being easily caused and the NRRO increasing.

For this reason, in the present embodiment, the thickness of the nickel alloy plating film 12 is set to be within a range of 4 μm or more and 7 μm or less.

Further, the nickel alloy plating film 12 is configured such that the average height of bulges generated around an indentation formed on a surface of the nickel alloy plating film 12 is set to be within a range of 10 nm or more and 50 nm or less. A method for measuring the average height of the bulges will be described with reference to FIGS. 2(a) and 2(b).

First, as shown in FIG. 2(a), the indentation 14 is formed by pressing a diamond indentor 13 whose tip has a square pyramid shape (an angle between the opposite faces thereof is 136 degrees) against the surface of the nickel alloy plating film 12 with a test force of 0.49 N (50 gf) for 10 seconds in a vertical direction.

Next, as shown in FIG. 2(b), heights H of the bulges 15 generated around the indentation 14 are measured. The heights H of the bulges 15 are heights of the crests of the bulges 15. The heights H of the bulges 15 may be measured using, for instance, a 3D Optical Profiler (available from ZYGO Corporation).

The measurement of the heights of the bulges is performed on one sample five times, and an average of the obtained heights of the bulges is used as the average height of the bulges.

If the substrate 10 for a magnetic recording medium in which the average height of the bulges 15 is less than 10 nm is hard, and the magnetic recording medium using the same and a magnetic head of the hard disk drive come into contact with each other, there is a risk of the magnetic head being damaged. On the other hand, an amount of deformation of the substrate 10 for a magnetic recording medium in which the average height of the bulges 15 exceeds 50 nm upon receiving a physical impact becomes too much.

The nickel alloy plating film 12 is preferably a nickel-phosphorus (NiP) alloy plating film or a nickel-tungsten-phosphorus (NiWP) alloy plating film. The NiP alloy preferably contains P within a range of 10% by mass or more and 15% by mass or less, and a balance that is Ni and inevitable impurities. The NiWP alloy preferably contains W within a range of 15% by mass or more and 22% by mass or less, P within a range of 3% by mass or more and 10% by mass or less, and a balance that is Ni and inevitable impurities. The nickel alloy plating film 12 is formed of a NiP alloy or a NiWP alloy, and thus hardness and flatness of the surface of the substrate 10 for a magnetic recording medium can be definitely improved.

<Method of Fabricating Substrate for Magnetic Recording Medium>

The substrate 10 for a magnetic recording medium of the present embodiment may be fabricated, for instance, by a method that includes a plating process of forming the nickel alloy plating film 12 on the aluminum alloy substrate 11 using a plating method, and a polishing working process of performing a polishing process on a surface of the aluminum alloy substrate with the nickel alloy plating film.

(Plating Process)

In the plating process, an electroless plating method is preferably used as the method for forming the nickel alloy plating film 12 on the aluminum alloy substrate 11. A plating film formed of a nickel alloy may be formed using a method used so far. For example, a plating solution that contains nickel sulfate as a nickel source and hypophosphite as a phosphorus source may be used as a plating solution for forming a NiP alloy plating film. A plating solution in which tungstate is added to the plating solution for forming the NiP alloy plating film may be used as a plating solution for forming a NiWP alloy plating film. For example, sodium tungstate, potassium tungstate, ammonium tungstate, or the like may be used as the tungstate.

The thickness of the nickel alloy plating film can be adjusted by an immersion time in a plating solution and a temperature of the plating solution. Plating conditions are not particularly limited, but preferably set pH of the plating solution to 5.0 to 8.6, a temperature of the plating solution to 70° C. to 100° C., and preferably 85° C. to 95° C., and an immersion time in the plating solution to 90 to 150 minutes.

An aluminum alloy substrate with the obtained nickel alloy plating film is preferably subjected to heat treatment. Thus, hardness of the nickel alloy plating film can be further increased, and the Young's modulus of the substrate for a magnetic recording medium can be further increased. The temperature of the heat treatment is preferably set to 200° C. or higher.

(Polishing Working Process)

In the polishing working process, a surface of the aluminum alloy substrate with the nickel alloy plating film obtained in the plating process is polished. The polishing working process preferably adopts a multistage polishing method having a polishing process of two or more stages using a plurality of independent polishing machines from the viewpoint of both improvement of surface quality that is smooth and has little damage and improvement of productivity. For example, a rough polishing process of polishing the aluminum alloy substrate using a first polishing machine while supplying a polishing solution containing alumina abrasive grains, and a finish polishing process of cleaning the polished aluminum alloy substrate and then polishing the cleaned aluminum alloy substrate using a second polishing machine while supplying a polishing solution containing colloidal silica abrasive grains are performed.

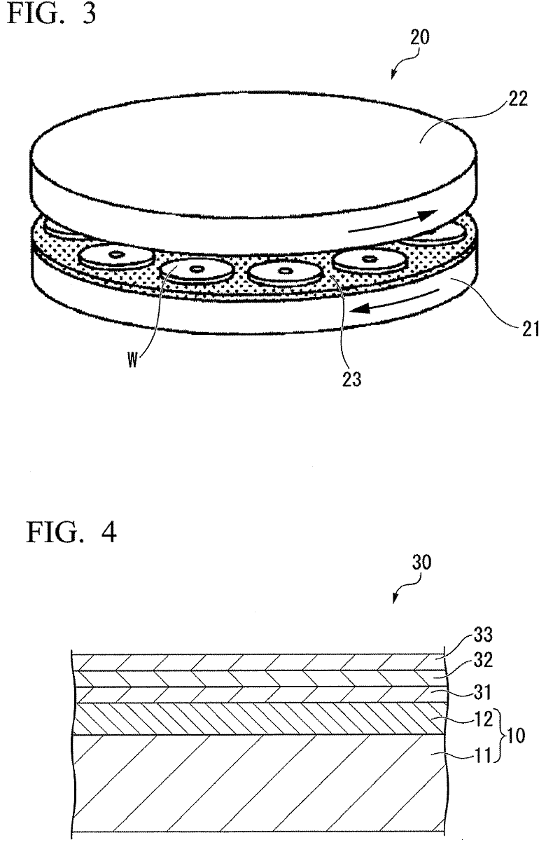

FIG. 3 is a perspective view showing an example of polishing machines that can be used in a polishing working process.

As shown in FIG. 3, each of the first and second polishing machines 20 includes a pair of upper and lower surface plates 21 and 22, and polishes both surfaces of a plurality of substrates W by means of polishing pads 23 provided on the surface plates 21 and 22 while sandwiching the substrates W between the surface plates 21 and 22 that are rotated in a direction opposite to each other.

[Magnetic Recording Medium]

FIG. 4 is a schematic sectional view showing an example of the magnetic recording medium according to the present embodiment.

As shown in FIG. 4, the magnetic recording medium 30 includes the aforementioned substrate 10 for a magnetic recording medium, and a magnetic layer 31 formed on a surface of the nickel alloy plating film 12 of the substrate 10 for a magnetic recording medium. A protective layer 32 and a lubricant layer 33 are further laminated on a surface of the magnetic layer 31 in this order.

The magnetic layer 31 is formed of a magnetic film in which an axis of easy magnetization is directed in a direction perpendicular to a substrate surface. The magnetic layer 31 is a layer that contains Co and Pt, and may be a layer that contains an oxide, Cr, B, Cu, Ta, Zr, or the like to further improve an SNR characteristic. The oxide contained in the magnetic layer 31 includes SiO₂, SiO, Cr₂O₃, CoO, Ta₂O₃, TiO₂, or the like. The magnetic layer 31 may be a layer formed of one layer, or a layer formed of a plurality of layers formed of materials having different compositions.

The thickness of the magnetic layer 31 is preferably set to 5 to 25 nm.

The protective layer 32 is a layer that protects the magnetic layer 31. For example, carbon nitride may be used as a material of the protective layer 32. The protective layer 32 may be a layer formed of one layer, or a layer formed of a plurality of layers.

The thickness of the protective layer 32 is preferably within a range of 1 nm or more and 10 nm or less.

The lubricant layer 33 is a layer that prevents contamination of the magnetic recording medium 30, and that reduces a frictional force of a magnetic head of a magnetic recording/reproducing device sliding on the magnetic recording medium 30 and improves durability of the magnetic recording medium 30. For example, a perfluoropolyether-based lubricant or an aliphatic hydrocarbon-based lubricant may be used as a material of the lubricant layer 33.

The thickness of the lubricant layer 33 is preferably within a range of 0.5 nm or more and 2 nm or less.

The layer constitution of the magnetic recording medium 30 according to the present embodiment is not particularly limited, and a well-known laminated structure may be applied to the layer constitution. For example, in the magnetic recording medium 30, an adhesion layer (not shown), a soft magnetic underlayer (not shown), a seed layer (not shown), and an orientation control layer (not shown) may be laminated between the substrate 10 for a magnetic recording medium and the magnetic layer 31 in this order.

Each of the magnetic layer 31, the protective layer 32, and the lubricant layer 33 that constitute the magnetic recording medium 30 according to the present embodiment has a nanometer-order thickness, and is extremely thin compared to the thickness (0.48 mm or more and 0.64 mm or less) of the substrate 10 for a magnetic recording medium. Accordingly, the thickness of the magnetic recording medium 30 is substantially the same as that of the substrate 10 for a magnetic recording medium, and is within a range of 0.48 mm or more and 0.64 mm or less. Since the magnetic recording medium 30 uses the aforementioned substrate 10 for a magnetic recording medium, an amount of deformation caused by a physical impact is small, and NRRO is reduced.

[Hard Disk Drive]

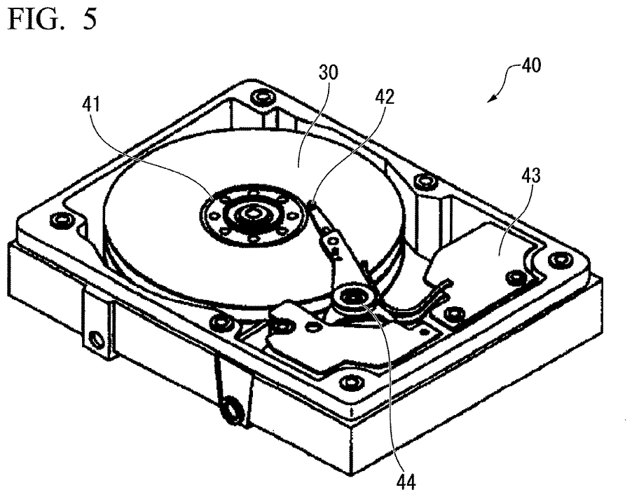

FIG. 5 is a perspective view showing an example of a hard disk drive according to the present embodiment.

As shown in FIG. 5, the hard disk drive 40 includes the aforementioned magnetic recording medium 30, a medium driving unit 41 that drives the magnetic recording medium 30 in a recording direction, a magnetic head 42 that is made up of a recording unit and a reproducing unit, a head moving unit 43 that moves the magnetic head 42 relative to the magnetic recording medium 30, and a recording/reproducing signal processing unit 44 that processes a recording/reproducing signal from the magnetic head 42. The hard disk drive 40 is a 3.5-inch type hard disk drive.

In the hard disk drive 40 according to the present embodiment, since the thickness of the magnetic recording medium 30 is thin within the range of 0.48 mm or more and 0.64 mm or less, the number of the magnetic recording mediums 30 stored in the drive case can be increased, and thus a recording capacity can be increased. Further, the magnetic recording medium 30 is small in an amount of deformation caused by a physical impact and is reduced in NRRO. For this reason, to reduce fluttering of the magnetic recording medium 30, a low molecular weight gas such as helium need not be particularly enclosed in the hard disk drive case.

According to the substrate 10 for a magnetic recording medium of the present embodiment configured as described above, since the size and the mass of the substrate 10 for a magnetic recording medium are within a prescribed range, the substrate in which the Young's modulus E, the density ρ, and the ratio E/ρ between the Young's modulus E and the density ρ are within a prescribed range is used as the aluminum alloy substrate 11, the thickness of the nickel alloy plating film 12 is within a prescribed range, and when the indentation is formed by pressing the diamond indentor 13 whose tip has a square pyramid shape against the surface of the nickel alloy plating film 12 with the test force of 0.49 N for 10 seconds in the vertical direction, the average height of the bulges 15 generated around the indentation 14 is within a prescribed range, although the substrate 10 for a magnetic recording medium has a size for a 3.5-inch type hard disk, the bulges are hardly formed on the surface of the substrate 10 by a physical impact, and the width of displacement (the NRRO) caused by fluttering is reduced.

Further, since the magnetic recording medium 30 of the present embodiment uses the aforementioned substrate 10 for a magnetic recording medium, the amount of deformation caused by a physical impact is small, and the NRRO is reduced.

Since the hard disk drive 40 of the present embodiment uses the aforementioned magnetic recording medium 30, the magnetic recording medium 30 is hardly deformed by a physical impact, for instance, when the hard disk drive 40 is dropped or when the magnetic head of the hard disk drive 40 and the magnetic recording medium come into contact with each other. For this reason, the hard disk drive 40 of the present embodiment can increase the recording capacity by thinning the thickness of the magnetic recording medium 30 (especially, the substrate 10 for a magnetic recording medium) and narrowing the distance between the magnetic head and the magnetic recording medium.

### EXAMPLES

Hereinafter, effects of the present invention are made more obvious by examples. The present invention is not limited to the following examples, and can be carried out through appropriate modification without departing from the subject matter of the present invention.

[Fabrication of Aluminum Alloy Substrates (Substrates 1 to 3)]

A pure Al ingot, Si, Fe, Mn, Cu, Mg, Zn, Sr, Zr, Ti, Ni, and Cr were prepared as an Al raw material. With regard to each raw material of the pure Al ingot, Si, Fe, Mn, Cu, Mg, Zn, Sr, Zr, Ti, Ni, and Cr, each raw material whose purity was higher than or equal to 99.9% by mass was prepared.

The raw materials of the prepared elements were weighed such that a composition after casting was a composition shown in Table 1 below, and were melted in air at 820° C., and an aluminum alloy ingot was made using a direct chill casting method (a DC casting method). A casting temperature was set to 700° C., and a casting speed was set to 40 to 60 mm/min. Next, the obtained aluminum alloy ingot was held and homogenized at 460° C. for 2 hours. Afterward, the homogenized aluminum alloy ingot was rolled into a sheet material having a thickness of 0.50 mm. The obtained aluminum alloy sheet material was punched in a disk shape that had a hole whose inner diameter was 24 mm in the center thereof and had a diameter of 96 mm, and was annealed at 380° C. for 1 hour. Afterward, surfaces and an end face of the aluminum alloy disk were cut by a diamond bite, and thereby an aluminum alloy substrate having a diameter of 95 mm and a thickness of 0.49 mm was obtained.

[Evaluation of Aluminum Alloy Substrates]

With regard to the obtained aluminum alloy substrates, the following items were evaluated. The evaluated results are shown in Table 1.

(Young's Modulus E)

A Young's modulus E was measured at room temperature on the basis of the method regulated by JIS Z 2280-1993 (Test method for Young's modulus of metallic materials at elevated temperature). The aluminum alloy substrate was cut out in a strip shape having a length of 50 mm, a width of 10 mm, and a thickness of 0.49 mm, and the Young's modulus was measured using this as a test piece.

(Density ρ)

A density ρ was measured by the Archimedes method.

(Ratio E/ρ)

A ratio between the Young's modulus E (in units of GPa) and the density ρ (in units of g/cm³) that were measured as described above was calculated.

### Examples 1 to 3 and Comparative Examples 1 to 5

Fabrication of Substrate for Magnetic Recording Medium

Aluminum alloy substrates (substrates 1 to 3) were immersed in a NiP alloy plating solution, and a Ni₈₈P₁₂ (a content of P was 12% by mass, and a balance was Ni) film as a NiP alloy plating film was formed on surfaces of the aluminum alloy substrates using an electroless plating method. Types of the aluminum alloy substrates used in the examples and the comparative examples are shown in Table 2 below.

The NiP alloy plating solution whose components were adjusted in amount was used by containing nickel sulfate (a nickel source) and sodium hypophosphite (a phosphorus source) and appropriately adding lead acetate, sodium citrate, and sodium borate such that the NiP alloy plating film having the above composition was obtained. The NiP alloy plating solution during the formation of the NiP alloy plating film was adjusted to pH 6 and a solution temperature of 90° C. Immersion times of the aluminum alloy substrates in the NiP alloy plating solution are shown in Table 2 below.

Next, each of the aluminum alloy substrates on which the NiP alloy plating film was formed was heated at 250° C. for 15 minutes, thereby obtaining an aluminum alloy substrate with a NiP alloy plating film.

Next, a polishing process was performed on a surface of the aluminum alloy substrate with a NiP alloy plating film using a 3-stage lapping machine having a pair of upper and lower surface plates as a polishing machine, thereby making a substrate for a magnetic recording medium. In this case, a suede type (available from Filwel Co., Ltd.) was used as a polishing pad. Alumina abrasive grains having D50 of 0.5 μm were used for first stage polishing, colloidal silica abrasive grains having D50 of 30 nm were used for second stage polishing, and colloidal silica abrasive grains having D50 of 10 nm were used for third stage polishing. Further, a polishing time for each stage was set to 5 minutes. The obtained substrate for a magnetic recording medium was sized such that the diameter was 95 mm, the inner diameter of the central hole was 25 mm, and the thickness was 0.49 mm.

[Evaluation of Substrates for Magnetic Recording Medium]

With regard to the obtained substrates for a magnetic recording medium, the following items were evaluated. The evaluated results are shown in Table 2 below.

(Thicknesses of NiP Alloy Plating Films)

Thicknesses of the NiP alloy plating films were measured using X-ray fluorescence analysis (XRF).

(Mass of Substrate for Magnetic Recording Medium)

The mass of the substrate for a magnetic recording medium was measured using an electronic balance.

(Average Height of Bulges Around Indentation of NiP Alloy Plating Film)

An indentation was formed by pressing a diamond indentor whose tip had a square pyramid shape against the surface of the NiP alloy plating film with a test force of 0.49 N (50 gf) for 10 seconds in a vertical direction. Next, heights of the bulges around the formed indentation were measured using a 3D optical profiler (available from ZYGO Corporation). An average of the heights of the bulges measured five times was used as an average height of the bulges.

(Impact Test Results when Drive was Driven)

The obtained substrate for a magnetic recording medium was assembled in a 3.5-inch type hard disk drive case, thereby making a dummy hard disk drive. An aluminum base (20 kg) was fastened to an upper portion of the dummy hard disk drive by bolts. The dummy hard disk drive to which the aluminum base was fastened was dropped from a height of 50 mm to apply an impact.

Afterward, the dummy hard disk drive was disassembled, the substrate for a magnetic recording medium was taken out, and the surfaces of the substrate for a magnetic recording medium were observed using an optical surface analyzer. A case where there was no damage to the surfaces was marked with “◯,” and a case where there was damage to the surfaces was marked with “x.”

(Fluttering Characteristic)

The fluttering characteristic was evaluated by measuring NRRO. A width of displacement caused by fluttering by rotating the substrate for a magnetic recording medium at 10000 rpm for 1 minute to be generated on an outermost circumferential surface of the substrate for a magnetic recording medium was measured using a He—Ne laser displacement gauge, and a maximum value of the obtained width of displacement was used as the NRRO.

The fluttering characteristic having NRRO of 3.4 or less was evaluated as “◯,” and the fluttering characteristic having NRRO exceeding 3.4 was evaluated as “x.”

TABLE 1

| | | | | | | | | | | | | | Young's | | |
|---|---|---|---|---|---|---|---|---|---|---|---|---|---|---|---|
| | | | | | | | | | | | | | modulus | | |
| | Composition (% by mass) | | | | | | | | | | | | E | Density ρ | Ratio |
| | Si | Fe | Mn | Cu | Mg | Zn | Sr | Zr | Ti | Ni | Cr | Al | (GPa) | (g/cm³) | E/ρ |
| Substrate 1 | 10.9 | 0.01 | 0.13 | 1.12 | 0.63 | 0.36 | 0.03 | 0.05 | 0.11 | 0.11 | 0.11 | Balance | 79.0 | 2.762 | 28.6 |
| Substrate 2 | 0.04 | 1.06 | 0.34 | 0.12 | 0.88 | 0.17 | 0.00 | 0.00 | 0.00 | 1.11 | 0.10 | Balance | 78.3 | 2.830 | 27.7 |
| Substrate 3 | 0.01 | 0.01 | 0.00 | 0.01 | 3.70 | 0.32 | 0.00 | 0.00 | 0.00 | 0.00 | 0.06 | Balance | 73.0 | 2.800 | 26.1 |

TABLE 2

| | | | Substrate for magnetic recording medium | | | | |
|---|---|---|---|---|---|---|---|
| | | | | | Average | | |
| | | | | | height of | Evaluation | |
| | | Immersion | | | bulges around | Impact | |
| | Type of | time in | Thickness of | | indentation of | resistance | |
| | aluminum | plating | NiP alloy | | NiP alloy | test when | |
| | alloy | solution | plating film | Mass | plating film | drive is | Fluttering |
| | substrate | (min) | (μm) | (g) | (nm) | driven | characteristic |
| Example 1 | Substrate 2 | 70 | 7 | 9.56 | 15.2 | ∘ | ∘ |
| Example 2 | Substrate 2 | 50 | 5 | 9.35 | 30.6 | ∘ | ∘ |
| Example 3 | Substrate 1 | 70 | 7 | 9.34 | 13.5 | ∘ | ∘ |
| Comparative | Substrate 2 | 30 | 3 | 9.15 | 40.0 | x | x |
| Example 1 | | | | | | | |
| Comparative | Substrate 2 | 170 | 17 | 10.59 | 10.0 | ∘ | x |
| Example 2 | | | | | | | |
| Comparative | Substrate 3 | 50 | 5 | 9.10 | 60.8 | x | x |
| Example 3 | | | | | | | |
| Comparative | Substrate 3 | 80 | 8 | 9.41 | 23.6 | x | x |
| Example 4 | | | | | | | |
| Comparative | Substrate 3 | 170 | 17 | 10.33 | 12.0 | ∘ | x |
| Example 5 | | | | | | | |

The substrates for a magnetic recording medium of Examples 1 to 3 in which the size, the mass, the Young's modulus E, the density ρ, and the ratio E/ρ of the aluminum alloy substrate, the thickness of the NiP alloy plating film, and the heights of the bulges around the indentation of the NiP alloy plating film were within the range of the present invention were marked with “◯” in both of the impact test when the drive was driven and the fluttering characteristic.

In contrast, the substrate for a magnetic recording medium of Comparative Example 1 in which the thickness of the NiP alloy plating film was thinner than the range of the present invention was marked with “x” in both of the impact test when the drive was driven and the fluttering characteristic. This is considered to be because the thickness of the NiP alloy plating film becomes thinner, and thus the rigidity of the entire substrate for a magnetic recording medium is lowered. Further, the substrate for a magnetic recording medium of Comparative Example 2 in which the thickness of the NiP alloy plating film was thicker than the range of the present invention was marked with “◯” in the impact test when the drive was driven and “x” in the fluttering characteristic. This is considered to be because the thickness of the NiP alloy plating film becomes thicker, and thus the mass of the entire substrate for a magnetic recording medium is increased.

Further, all Comparative Examples 3 to 5 using the substrate 3 in which the Young's modulus of the aluminum alloy substrate was lower than the range of the present invention were marked with “x” in the fluttering characteristic. On the other hand, even in the case where the substrate 3 was used, as the NiP alloy plating film becomes thicker, the average height of the bulges around the indentation of the NiP alloy plating film becomes lower, and the impact test when the drive was driven was marked with “x” even in Comparative Example 4 (the average height of the bulges was 23.6 nm). It is understood from this result that there is a need to enhance the rigidity of the aluminum alloy substrate in order to curb the deformation of the substrate for a magnetic recording medium caused by an impact.

### EXPLANATION OF REFERENCES

10 Substrate for magnetic recording medium
11 Aluminum alloy substrate
12 Nickel alloy plating film
13 Diamond indentor
14 Indentation
15 Bulge
20 Polishing machine
21, 22 Surface plate
23 Polishing pad
30 Magnetic recording medium
31 Magnetic layer
32 Protective layer
33 Lubricant layer
40 Hard disk drive
41 Medium driving unit
42 Magnetic head
43 Head moving unit
44 Recording/reproducing signal processing unit

What is claimed is:

1. A substrate for a magnetic recording medium comprising:
an aluminum alloy substrate; and
a nickel alloy plating film formed on at least one surface of the aluminum alloy substrate,
wherein the substrate for a magnetic recording medium has a diameter within a range of 95 mm or more and 98 mm or less, a disk shape having a hole whose inner diameter is within a range of 19 mm or more and 26 mm or less in the center thereof, a thickness within a range of 0.48 mm or more and 0.64 mm or less, and a mass within a range of 9.0 g or more and 15.0 g or less;
the aluminum alloy substrate has a Young's modulus (E) of 74 GPa or more, a density (ρ) of 2.75 g/cm³ or less, and a ratio (E/ρ) of 27 or more between the Young's modulus (E) in units of GPa and the density (ρ) in units of g/cm³; and
the nickel alloy plating film has a thickness within a range of 4 μm or more and 7 μm or less, and when an indentation is formed by pressing a diamond indentor whose tip has a square pyramid shape against a surface of the nickel alloy plating film with a test force of 0.49 N for 10 seconds in a vertical direction, an average height of bulges generated around the indentation is within a range of 10 nm or more and 50 nm or less.

2. A magnetic recording medium comprising: a substrate for a magnetic recording medium; and a magnetic layer formed on a surface of the substrate for a magnetic recording medium,
wherein the substrate for a magnetic recording medium is the substrate for a magnetic recording medium defined in claim 1, and the magnetic layer is formed on the surface of the substrate for a magnetic recording medium on which the nickel alloy plating film is formed.

3. A hard disk drive comprising a magnetic recording medium,
wherein the magnetic recording medium is the magnetic recording medium defined in claim 2.
